(19) United States
(12) Patent Application Publication
(10) Pub. No.: US 2011/0156856 A1
(43) Pub. Date: Jun. 30, 2011

(54) Electrical fuse devices

(76) Inventors: Soojung Hwang, Seoul (KR); Deokkee Kim, Seoul (KR); Youngchang Joo, Seoul (KR)

(21) Appl. No.: 12/929,921

(22) Filed: Feb. 24, 2011

Related U.S. Application Data
(62) Division of application No. 12/289,833, filed on Nov. 5, 2008, now abandoned.

(30) Foreign Application Priority Data
Apr. 24, 2008 (KR) 10-2008-0038256

(51) Int. Cl. H01H 85/04

(52) U.S. Cl. 337/290

(57) ABSTRACT

An electrical fuse device includes a cathode and an anode formed apart from each other and a fuse link connecting the cathode and the anode. The cathode includes a first region and a second region. The second region is arranged between the first region and the fuse link. A width of the second region may be greater than a width of the first region.

### PRIORITY STATEMENT

This application is a divisional of co-pending application Ser. No. 12/289,833 filed on Nov. 5, 2008 and from which priority is claimed under 35 U.S.C. §120. The application also claims priority under 35 U.S.C. 119 from Korean Patent Application No. 10-2008-0038256, filed on Apr. 24, 2008 in the Korean Patent Office. The entire contents of these two applications are hereby incorporated herein by reference.

### BACKGROUND

### Description of the Related Art

Conventional fuse devices are used in semiconductor memory devices or logic devices for various purposes, such as to repair defective cells, store chip identification (ID), circuit customization, etc. For example, among a relatively large number of cells in a memory device, cells determined as defective may be replaced with redundancy cells by using a fuse device. As a result, decreases in a manufacturing yield due to the defective cells may be suppressed and/or resolved.

Conventionally, there are two types of fuse devices: a laser-blown type and an electrically-blown type. A laser-blown type fuse device uses a laser beam to blow a fuse line. However, when irradiating the laser beam at a particular fuse line, fuse lines adjacent to the particular fuse line and/or other devices may be damaged.

An electrically-blown type fuse device applies a programming current to a fuse link so that the fuse link is blown due to an electromigration (EM) effect and a Joule heating effect. The method of electrically blowing a fuse may be used after packaging of a semiconductor chip is completed, and a fuse device employing the method is referred to as an electrical fuse device. However, conventional electrical fuse devices such as this require a relatively high programming voltage, which may reduce reliability of semiconductor memory devices and/or logical devices including the electrical fuse device. Furthermore, it is relatively difficult to reduce the size of the electrical fuse device due to a relatively small sensing margin.

### SUMMARY

Example embodiments provide electrical fuse devices including a fuse link capable of being electrically blown.

At least one example embodiment provides an electrical fuse device including a cathode and an anode formed apart from each other. A fuse link may connect the cathode and the anode. The cathode may include a first region and a second region disposed between the first region and the fuse link. The width of the second region may be greater than that of the first region. The cathode, the fuse link, and the anode may be disposed on a substrate in a direction parallel to the substrate. The width of the second region may increase toward the fuse link from the first region. Alternatively, the width of the second region may be constant or substantially constant.

According to at least some example embodiments, at least part of the fuse link contacting the anode may increase toward the anode. The fuse link may include a relatively weak point as a region capable of being electrically blown more easily than other regions of the fuse link. The weak point may be closer to the cathode than to the anode. The width of the weak point may be smaller than that of the other regions of the fuse link. The weak point may be a bent region.

At least one other example embodiment provides an electrical fuse device including a cathode and an anode formed apart from each other. A fuse link may connect the cathode and the anode. The width of the fuse link may increase toward the anode from the cathode. The fuse link may include a weak point as a region capable of being electrically blown more easily than other regions of the fuse link. The weak point may be closer to the cathode than to the anode.

According to at least some example embodiments, the cathode, the fuse link, and the anode may be disposed on a substrate in a direction parallel to the substrate. The width of the fuse link may either gradually increase or increase in stepped increments. Portions of the cathode around the fuse link may extend toward the anode.

At least one other example embodiment provides an electrical fuse device including an anode, a fuse link, and a cathode sequentially stacked in a direction perpendicular to a substrate. The size of the anode may be smaller than that of the cathode. At least part of the fuse link contacting the anode may increase toward the anode. Portions of the cathode around the fuse link may extend toward the anode. The cathode may include a first region and a second region disposed between the first region and the fuse link. The width of the second region may be greater than that of the first region. The width of the second region may gradually increase toward the fuse link from the first region. Alternatively, the width of the second region may be constant or substantially constant.

At least one other example embodiment provides an electrical fuse device including a cathode and an anode separated from one another by a fuse link. The fuse link may have a first end connected to the cathode and a second end connected to the anode. The fuse link may be arranged between the cathode and the anode. The fuse link may have a width that varies between the first end and the second end.

### BRIEF DESCRIPTION OF THE DRAWINGS

The present invention will become more apparent by describing in detail exemplary embodiments thereof with reference to the attached drawings in which:

FIGS. 1 through 7 are plan views of electrical fuse devices according to example embodiments;

FIGS. 8 and 9 are plan views of weak points of electrical fuse devices, according to example embodiments;

FIGS. 10 through 13 are plan views of electrical fuse devices according to example embodiments;

FIG. 14A is a perspective view of an electrical fuse device according to another example embodiment;

FIG. 14B is a cross-sectional view of the electrical fuse device of FIG. 14A, taken along a line A-A′ of FIG. 14A, according to an example embodiment;

FIG. 14C is a cross-sectional view of the electrical fuse device of FIG. 14A, taken along a line B-B′ of FIG. 14A, according to an example embodiment; and

FIGS. 15 through 29 are cross-sectional views of electrical fuse devices according to example embodiments.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

Further, it will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

Further still, it will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Electrical fuse devices according to example embodiments will now be described more fully with reference to the accompanying drawings. In the drawings, the thicknesses of layers and regions are exaggerated for clarity. Like reference numerals in the drawings denote like elements, and thus descriptions of the similar elements will not be repeated.

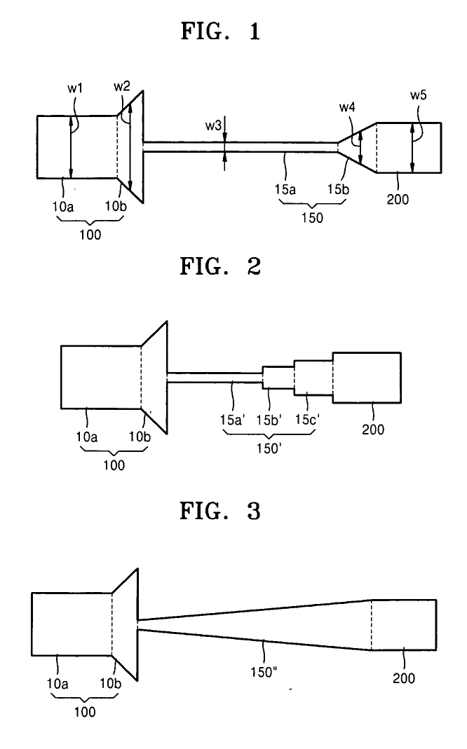

FIG. 1 is a plan view of an electrical fuse device according to an example embodiment.

Referring to FIG. 1, the electrical fuse device according to at least this example embodiment may include a cathode 100 and an anode 200 disposed apart from each other. A fuse link 150 may be disposed between the cathode 100 and the anode 200 to connect the cathode 100 to the anode 200. The cathode 100, the fuse link 150, and the anode 200 may be disposed sequentially on a substrate (not shown) in a direction parallel to the substrate.

The cathode 100 may include a first region 10a and a second region 10b. The second region 10b may be disposed between the first region 10a and the fuse link 150 such that the first region 10a is separated from the fuse link 150. A width w2 of at least a portion of the second region 10b may be greater than a width w1 of the first region 10a. The width w1 of the first region 10a may be constant, whereas the width w2 of the second region 10b may gradually increase toward the fuse link 150 from the first region 10a. In one example, the second region 10b may have a trapezoid shaped cross-section.

The fuse link 150 may include a first region 15a contacting the cathode 100 and may include a second region 15b between the first region 15a and the anode 200. The second region 15b may connect the first region 15a with the anode 200.

A width w3 of the first region 15a of the fuse link 150 may be constant. The width w3 may be less or significantly less than the widths w1 and w2 of the first and second regions 10a and 10b of the cathode 100. The width w3 may also be less or significantly less than a width w5 of the anode 200. A width w4 of the second region 15b of the fuse link 150 may increase (e.g., gradually increase) toward the anode 200 from the first region 15a.

The width w3 of the first region 15a of the fuse link 150 may be in a range of several tens of nanometers (nm) to several hundreds of nm, whereas the length of the first region 15a may be in a range of several tens of nm to several micrometers (μm). When electrical current exceeding a critical current flows through the first region 15a of the fuse link 150, a given, desired or predetermined region of the first region 15a of the fuse link 150 may be blown (cut) due to an electromigration (EM) effect, a thermomigration (TM) effect and/or a Joule hearing effect. As the width w3 of the first region 15a of the fuse link 150 decreases and the length of the first region 15a of the fuse link 150 increases, the given, desired or predetermined region may be blown more easily. According to at least some example embodiments, the length to width ratio of the first region 15a may be greater than or equal to about 4.

The anode 200 may be an extension of the second region 15b of the fuse link 150, and may have a constant or substantially constant width w5 as discussed above. The size (e.g., length and/or width) of the anode 200 may be smaller than that of the cathode 100. The shapes of the cathode 100, the fuse link 150, and the anode 200 may vary. The sizes and the size ratio of the cathode 100, the fuse link 150, and the anode 200 may also vary. Alternatively, the second region 15b may be considered as a part of the anode 200 rather than as a part of the fuse link 150.

The structure illustrated in FIG. 1 may be modified to structures illustrated in FIGS. 2 through 6. FIGS. 2 through 6 are plan views of electrical fuse devices according to other example embodiments.

Referring to FIG. 2, the electrical fuse device according to an example embodiment may include a cathode 100, a fuse link 150′ and an anode 200. The width of the fuse link 150′ may increase in step increments toward the anode 200 from the cathode 100. For example, the fuse link 150′ may include first through third regions 15a′ through 15c′ disposed sequentially between the cathode 100 and the anode 200. The widths of the regions 15a′-15c′ of the fuse link 150′ may increase from the first region 15a′ toward the third region 15c′. For example, the width of the first region 15a′ may be less than the width of the second region 15b′, which may be less than the width of the third region 15c′.

Centers of the first through third regions 15a′ through 15c′ may be aligned on the same axis. A value obtained by dividing the length of the first region 15a′ of the fuse link 150′ by the width of the first region 15a′ may be greater than or equal to about 4. The width of the anode 200 may be greater than the width of the third region 15c′. Although not shown in the figures, the fuse link 150′ may include four or more regions having different widths, wherein the widths of the regions increase toward the anode 200. Alternatively, the third region 15c′ may be omitted, and the second region 15b′ and the anode 200 may directly contact each other. The configuration illustrated in FIG. 2 may be similar or substantially similar to the configuration illustrated in FIG. 1 except for the structure of the fuse link 150′. In alternative example embodiments, the second region 15b′ and the third region 15c′ may be considered parts of the anode 200 rather than parts of the fuse link 150′.

Referring to FIG. 3, the width of a fuse link 150″ may gradually increase from the cathode 100 to the anode 200. The width of the anode 200 may be same or substantially the same as the width of an end of the fuse link 150″ contacting the anode 200. A value obtained by dividing the length of the fuse link 150″ with the average width of the fuse link 150″ may be greater than or equal to about 3. The configuration illustrated in FIG. 3 may be similar or substantially similar to the configuration illustrated in FIG. 1 except for the structure of the fuse link 150″.

Referring to FIGS. 4 through 6, the configurations illustrated in these example embodiments may be similar or substantially similar to the configurations illustrated in FIGS. 1 through 3, respectively, except for the structure of the second region 10b′. As shown in FIGS. 4 through 6, a width w2′ of a second region 10b′ of cathode 100′ may be constant or substantially constant in these example embodiments.

Although not illustrated in FIGS. 1 through 6, the cathodes 100 and 100′ and/or the anode 200 may be connected to a given, desired or predetermined sensing circuit and a programming transistor. Because the sensing circuit and the programming transistor are well-known to those of ordinary skill in the art, detailed descriptions thereof are omitted.

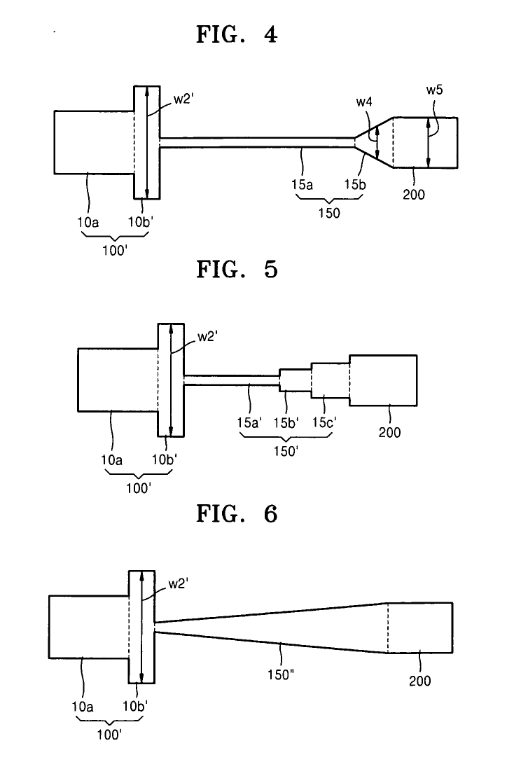

In the example embodiments shown in FIGS. 1 and 4, the width of the second region 15b of the fuse link 150 gradually increases toward the anode 200. In the example embodiments shown in FIGS. 2 and 5, the width of the fuse link 150′ increases in stepped increments toward the anode 200. In the example embodiments shown in FIGS. 3 and 6, the width of the fuse link 150″ gradually increases toward the anode 200. As a result, according to example embodiments the density of electrical current flowing from the fuse links 150, 150′, and 150″ to the anode 200 may gradually decrease or decrease in stepped decrements. Thus, EM from the fuse links 150, 150′, and 150″ to the anode 200 may occur more easily.

Meanwhile, the cathodes 100 and 100′ have a structure capable of inducing a change (e.g., significant change) in current density between the cathodes 100 and 100′ and the fuse links 150, 150′, and 150″. Because the width of regions of the cathodes 100 and 100′ adjacent to the fuse links 150, 150′, and 150″ is larger than other regions of the cathodes 100 and 100′, the change in width between the cathodes 100 and 100′ and the fuse links 150, 150′, and 150″ may be relatively significant. Thus, EM from the cathodes 100 and 100′ to the fuse links 150, 150′, and 150″ may occur less easily relative to EM from the fuse links 150, 150′, and 150″ to the anode 200. Accordingly, when the change of the widths between the cathodes 100 and 100′ and the fuse links 150, 150′, and 150″ is significant, and the change of the widths between the fuse links 150, 150′, and 150″ and the anode 200 is gradual or stepped, EM from the cathodes 100 and 100′ to the fuse links 150, 150′, and 150″ may not occur easily, whereas EM from the fuse links 150, 150′, and 150″ to the anode 200 may occur relatively easily. Therefore, the fuse links 150, 150′, and 150″ may be blown relatively easily.

Thus, according to example embodiments, electrical fuse devices with lower programming voltage, faster programming speed, and/or relatively large sensing margins may be realized. If the sensing margin is relatively large, the configuration of a sensing circuit connected to the cathodes 100 and 100′ or the anode 200 may be simplified, which may be advantageous for more integrated electrical devices. Semiconductor memory devices or logic devices including electrical fuse devices according to example embodiments may have improved reliability and/or lower operating voltage.

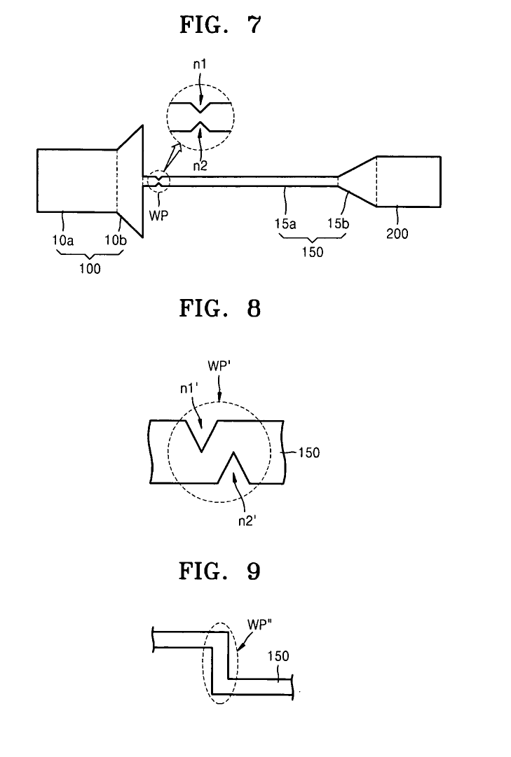

FIG. 7 is a plan view of an electrical fuse device according to another example embodiment. The electrical fuse device illustrated in FIG. 7 is similar to the electrical fuse device shown in FIG. 1 except that the electrical fuse device in FIG. 7 may further include a weak region or weak point WP.

Referring to FIG. 7, the first region 15a of a fuse link 150 may include the weak point WP. The weak point WP may be a region having a width less than widths of the other regions 15a and 15b of the fuse link 150. The weak point WP may be formed by two notches n1 and n2 formed at both sides of the first region 15a of the fuse link 150. The two notches n1 and n2 may be formed on the same axis. Although the notches n1 and n2 illustrated in FIG. 7 are v-shaped, the notches n1 and n2 may have other shapes; for example, the notches n1 and n2 may be u-shaped. The weak point WP may be formed by using a lithography method using an optical proximity correction (OPC) principle or other methods.

Because current density at the weak point WP is higher than in other regions of the fuse link 150, electrical blowing may occur more easily at the weak point WP relative to other regions of the fuse link 150. The weak point WP may be located closer to the cathode 100 than to the anode 200. Because a relatively large eddy current flows around a region of the fuse link 150 closer or relatively close to the cathode 100, the weak point WP may be blown more easily when the weak point WP is closer to the cathode 100 as compared to when the weak point WP is located further from the cathode 100.

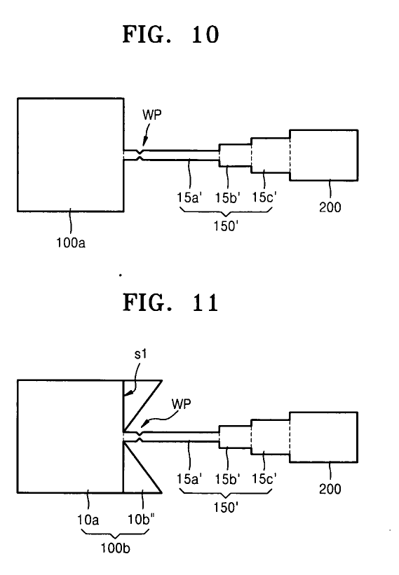

The weak point WP illustrated in FIG. 7 is merely an example. In this regard, FIGS. 8 and 9 are plan views of weak points WP′ and WP″ of electrical fuse devices according to other example embodiments.

Referring to FIG. 8, the weak point WP′ is formed by two notches n1′ and n2′ formed at side surfaces of a fuse link 150a in a v-shape such that the two notches n1′ and n2′ are diagonally opposite to each other; for example, offset in a vertical direction. Referring to FIG. 9, the weak region WP″ of a fuse link 150a may be a bent region. Because current is concentrated at edges of the bent region, the bent region may be electrically blown or cut more easily. The fuse links 150, 150′, and 150″ illustrated in FIGS. 2 through 6 may also include any of the weak points WP, WP′, and WP″ illustrated in FIGS. 7 through 9.

FIGS. 10 through 13 are plan views of electrical fuse devices according to other example embodiments.

Referring to FIG. 10, the shape of a cathode 100a may be a rectangle with a constant or substantially constant width. In this example embodiment, a first region 15a′ of a fuse link 150′ may have a weak point WP similar or substantially similar to the weak point WP in FIG. 7. The configuration illustrated in FIG. 10 may be similar or substantially similar to the configuration illustrated in FIG. 5 except for the shape of the cathode 100a and the inclusion of the weak point WP in the fuse link 150′.

Referring to FIG. 11, a cathode 100b may include a first region 10a having a shape of a rectangle with a constant or substantially constant width. A fuse link 150′ may contact the center of a first side surface s1 of the first region 10a. The cathode 100b may further include a second region 10b″. The second region 10b″ may include a portion extending toward the anode 200 from the first side surface s1 at each side of the fuse link 150′. In this example embodiment, the portions of the second region 10b″ are triangular-shaped, as illustrated in FIG. 11; however, example embodiments are not limited thereto, and thus, the shape of the second region 10b″ may vary.

If the cathode 100b further includes the second region 10b″, the difference in current density between the cathode 100b and the fuse link 150′ may be relatively significant. The configuration illustrated in FIG. 11 may be similar or substantially similar to the configuration illustrated in FIG. 10 except for the shape of the cathode 100b.

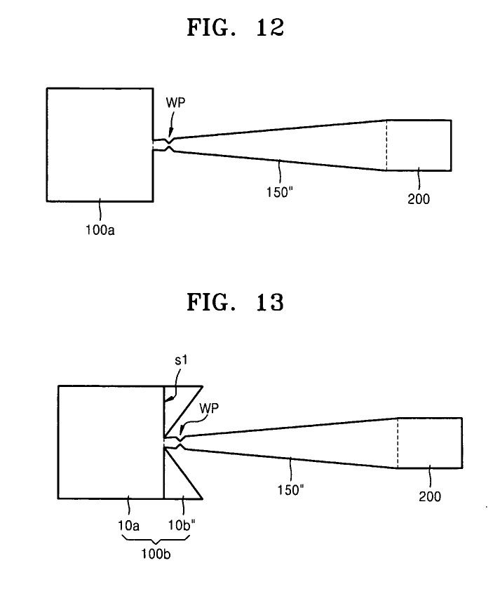

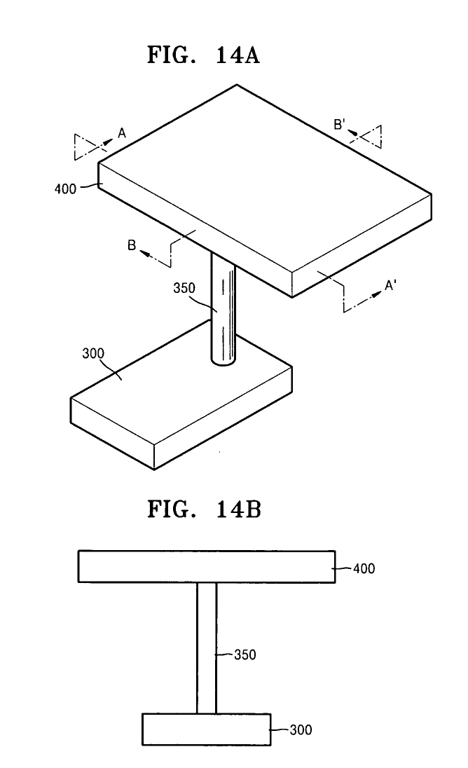

Fuse links 150″ illustrated in FIGS. 12 and 13 are modified forms of the fuse links 150′ illustrated in FIGS. 10 and 11. The fuse links 150″ may have weak points WP in a region closer or relatively close to the cathodes 100a and 100b, and widths of the regions of the fuse links 150″ other than the region of the fuse links 150″ including the weak point WP may increase (e.g., gradually increase) from cathodes 100a and 100b to the anodes 200. Alternatively, the weak points WP illustrated in FIGS. 10 through 13 may be replaced with the weak points WP′ or WP″ illustrated in FIGS. 8 and 9.

The electrical fuse devices illustrated in FIGS. 1 through 13 may include a poly-silicon layer and a silicide layer stacked sequentially on a substrate. The electrical fuse devices illustrated in FIGS. 1 through 13 may also have a single metal layer structure or a multi-layer metal structure. In the case where an electrical fuse device has a single metal layer structure or a multi-layer metal structure, the electrical fuse device may include a metal layer formed of W, Al, Cu, Ag, Au, Pt, or the like and may include another metal layer formed of Ti, TiN, Ta, TaN, TiSi, TaSi, TiSiN, TaSiN, TiAl₃, TiON, or the like.

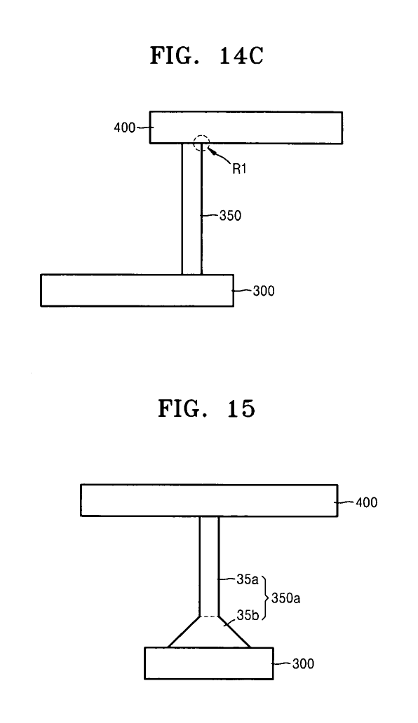

FIG. 14A is a perspective view of an electrical fuse device according to another example embodiment. FIGS. 14B and 14C are cross-sectional views of the electrical fuse device of FIG. 14A, taken along lines A-A′ and B-B′ of FIG. 14A, respectively, according to example embodiments.

Referring to FIGS. 14A through 14C, a fuse link 350 may be disposed on an anode 300, and a cathode 400 may be disposed on the fuse link 350. In this example, the anode 300, the fuse link 350, and the anode 400 may be disposed sequentially on a substrate (not shown). The anode 300 and the cathode 400 may be rectangular, circular or similarly shaped pads. The fuse link 350 may be a cylindrical, rectangular or similarly shaped pillar. However, example embodiments are not limited thereto, and thus the shapes of the anode 300, the cathode 400, and/or the fuse link 350 may vary.

The anode 300 and the cathode 400 may be arranged such that at least a portion (e.g., an end portion) of the anode 300 and at least a portion (e.g., an end portion) of the cathode 400 partially overlap when viewed from above. The fuse link 350 may be disposed in the overlapped portion. Alternatively, the centers of at least two of the anode 300, the fuse link 350, and the cathode 400 may be arranged on the same vertical axis. The size of the anode 300 may be smaller than that of the cathode 400. Electromigration (EM) from the fuse link 350 to the anode 300 may occur more easily than EM from the cathode 400 to the fuse link 350 due to the fact that the anode 300 is smaller than the cathode 400. When electrical current flows from the anode 300 to the cathode 400 (when electrons move from the cathode 400 to the anode 300) flow of the electrons may be concentrated to a corner R1 (refer to FIG. 14C) of a region at which the fuse link 350 and the cathode 400 contact each other such that electrical blowing due to the EM effect, the TM effect, and/or the Joule heating effect may occur at the corner R1.

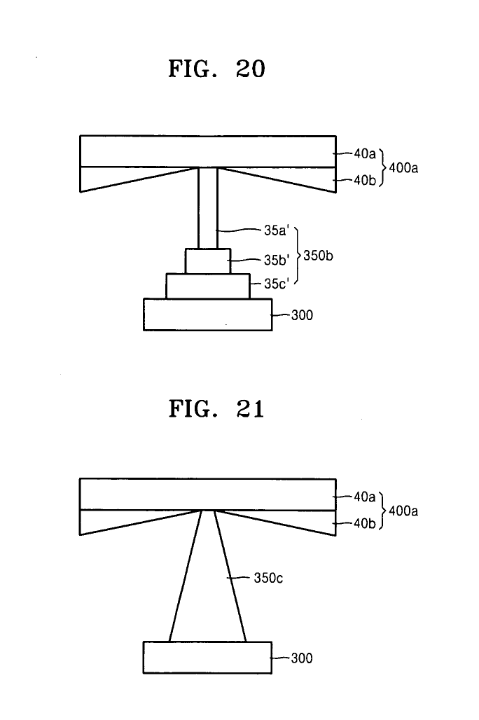

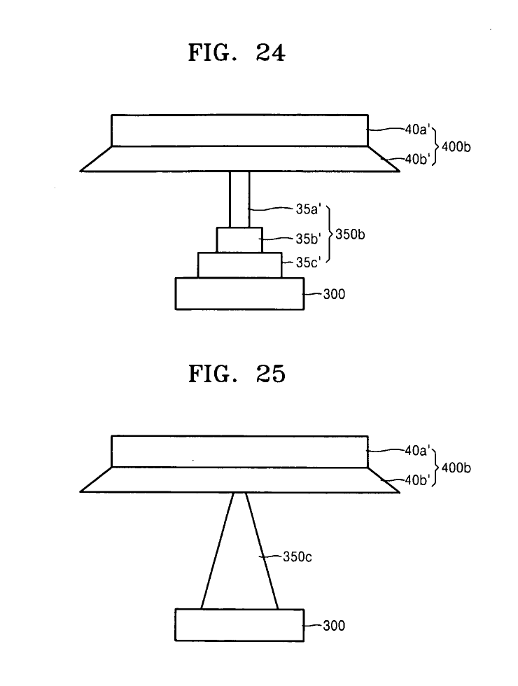

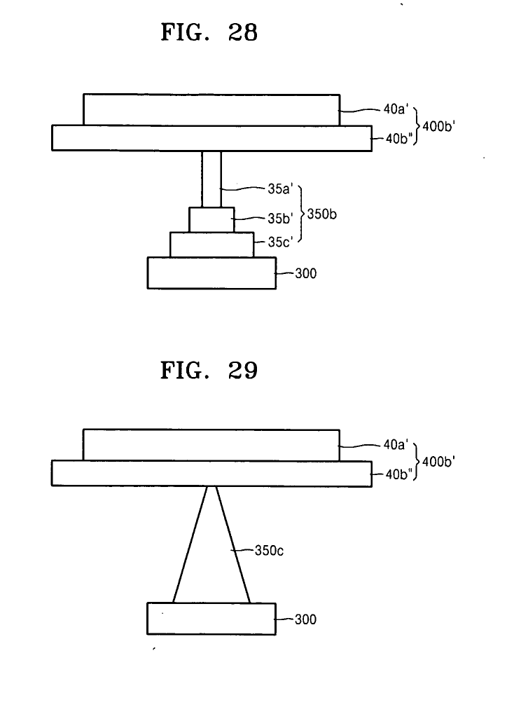

An electrical fuse device having a three-dimensional stack layer structure such as the electrical fuse device illustrated in FIG. 14A may have various modifications. Examples of the variations are illustrated in FIGS. 15 through 29.

FIGS. 15 through 29 are cross-sectional views of electrical fuse devices according to other example embodiments and may be views similar to that obtained along the line A-A of FIG. 14A.

Referring to FIG. 15, a fuse link 350a may include a first region 35a contacting a cathode 400 and a second region 35b arranged between the first region 35a and an anode 300. The width of the first region 35a may be constant, whereas the width of the second region 35b may increase from the first region 35a to the anode 300. In alternative example embodiments, the second region 35b may be considered as part of the anode 300 rather than part of the fuse link 350a.

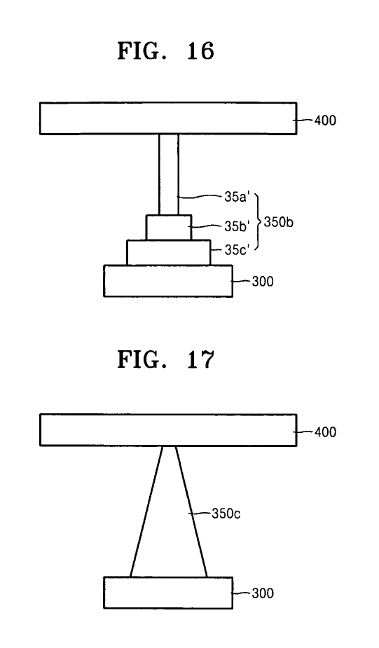

Referring to FIG. 16, the width of a fuse link 350b may increase in stepped increments from the cathode 400 to the anode 300. For example, the fuse link 350b may include first through third regions 35a′ through 35c′ arranged sequentially between the cathode 400 and the anode 300. The width of the fuse link 350b may increase from the first region 35a′ to the third region 35c′, and the centers of the first through third regions 35a′ through 35c′ may be arranged on the same axis. In this example, the width of the first region 35a′ may be less than the width of the second region 35b′, which may be less than the width of the third region 35c′. The width of the anode 300 may be greater than the width of the third region 35c′. Although not shown in the figures, the fuse link 350b may have four or more regions having widths increasing toward the anode 300. Alternatively, the third region 35c′ may be omitted, and the second region 35b′ may contact the anode 300 directly. In alternative example embodiments, the second region 35b′ and/or the third region 35c′ may be considered part of the anode 300 rather than part of the fuse link 350b.

Referring to FIG. 17, the width of a fuse link 350c may increase (e.g., gradually increase) from the cathode 400 to the anode.

The configurations illustrated in FIGS. 15 through 17 may be similar or substantially similar to the configuration illustrated in FIG. 14B except for the shapes of the fuse links 350a, 350b, and 350c. Due to the shapes of the fuse links 350a, 350b, and 350c, EM from the fuse links 350a, 350b, and 350c to the anode 300 may occur more easily.

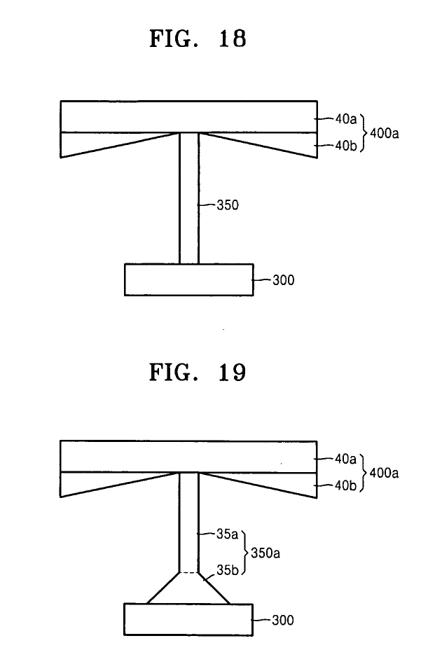

The configurations illustrated in FIGS. 18 through 21 may be similar or substantially similar to the configurations illustrated in FIGS. 14B, 15, 16, and 17, except for the shape of the cathode 400a. Referring to FIGS. 18 through 21, a cathode 400a may include a cuboid-shaped first region 40a, and a second region 40b extending from the bottom of the first region 40a toward an anode 300. The second region 40b may be a region extending from the first region 40a to the anode 300 around fuse links 350, 350a, 350b, and 350c.

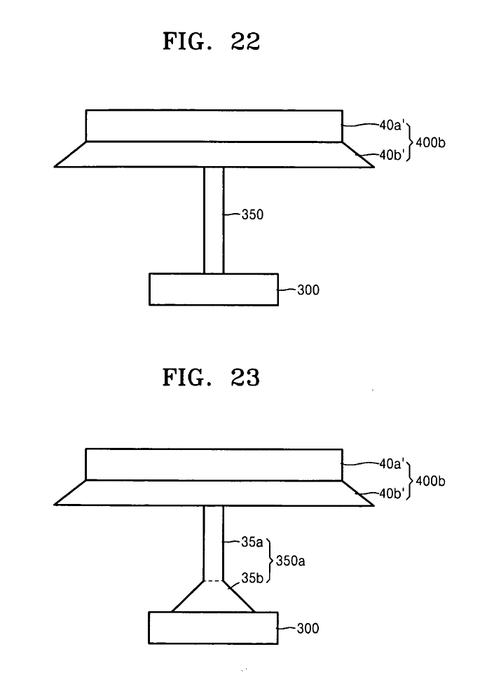

Referring to FIGS. 22 through 25, a cathode 400b may include a first region 40a′ located apart from fuse links 350, 350a, 350b, and 350c, and a second region 40b′ arranged between the first region 40a′ and the fuse links 350, 350a, 350b, and 350c. The width of the second region 40b′ may be greater than that of the first region 40a′, and may increase toward the fuse links 350, 350a, 350b, and 350c.

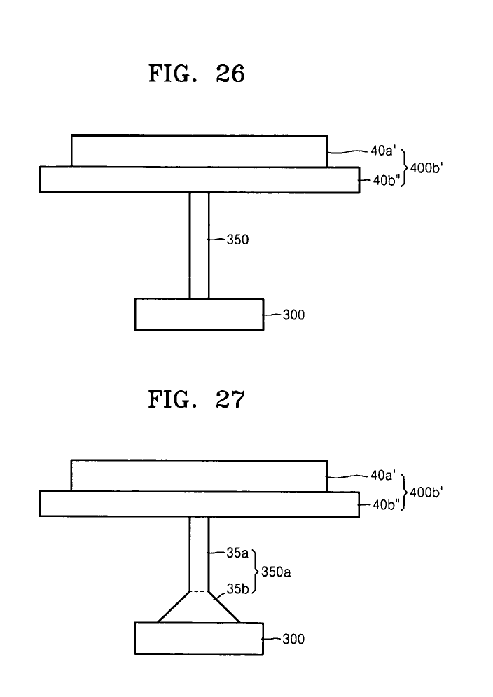

Referring to FIGS. 26 through 29, a cathode 400b′ may include a first region 40a″ located apart from fuse links 350, 350a, 350b, and 350c, and a second region 40b″ arranged between the first region 40a″ and the fuse links 350, 350a, 350b, and 350c. The width of the second region 40b″ may be greater than that of the first region 40a″, but may be constant or substantially constant.

Due to the shapes of the cathodes 400a, 400b, and 400b′ illustrated in FIGS. 18 through 29, EM from the cathodes 400a, 400b, and 400b′ to the fuse links 350, 350a, 350b, and 350c may be more difficult.

Although not specifically illustrated, the fuse links 350, 350a, 350b, and 350c illustrated in FIGS. 14A through 29 may have a weak point similar to the weak points WP, WP′, or WP″ illustrated in FIGS. 7 through 9. In these example embodiments, the weak point may be formed closer to the cathodes 400, 400a, 400b, and 400b′ than the anode. With the inclusion of such a weak point, the fuse links 350, 350a, 350b, and 350c may be electrically blown more easily.

Electrical fuse devices according example embodiments have structures in which EM from a fuse link to an anode may occur more easily than EM from a cathode to a fuse link. Also, the electrical fuse devices may include a weak point, which is more easily blown in a region of the fuse link close to the cathode. Thus, according to example embodiments, electrical fuse devices with relatively low programming voltage, relatively fast programming speed, and/or a relatively large sensing margin, which is advantageous for improving integration, may be fabricated.

A plurality of the fuse devices according to example embodiments described above may be arranged to form a two-dimensional array, and may be applied for various purposes to semiconductor memory devices, logic devices, microprocessors, field programmable gate arrays (FPGA), very large scale integration (VLSI) circuits, etc.

While the present invention has been particularly shown and described with reference to example embodiments thereof, it will be understood by one of ordinary skill in the art that various changes in form and details may be made therein without departing from the spirit and scope of the present invention as defined by the following claims. For example, one of ordinary skill in the art understands that structures and components of the electrical fuse devices illustrated in FIGS. 1 through 29 may be changed and varied. It will also be understood that electrical fuse devices according to example embodiments may be formed on a bulk Si substrate, a silicon on insulator (SOI) substrate, a GaAs substrate, and other substrates. Therefore, the scope of the invention is defined not by the detailed description, but by the appended claims, and all differences within the scope will be construed as being included in the present invention.

What is claimed is:

1. An electrical fuse device comprising:
a cathode and an anode arranged apart from each other, the cathode including a first region and a second region; and
a fuse link connecting the cathode and the anode, the second region being disposed between the first region and the fuse link, and a width of the second region being greater than a width of the first region.

2. The electrical fuse device of claim 1, wherein the width of the second region is constant.

3. The electrical fuse device of claim 1, wherein the fuse link includes a weak region that can be electrically blown more easily than other regions of the fuse link.

4. The electrical fuse device of claim 3, wherein the weak region is a bent region.

5. An electrical fuse device comprising:
a cathode and an anode arranged apart from each other; and
a fuse link connecting the cathode and the anode, a width of the fuse link increasing from the cathode toward the anode, the fuse link including a weak region that can be electrically blown more easily than other regions of the fuse link, and the weak region being located closer to the cathode than to the anode.

6. The electrical fuse device of claim 5, wherein the weak region is a bent region.

7. The electrical fuse device of claim 5, wherein portions of the cathode around the fuse link extend toward the anode.

8. An electrical fuse device comprising:
an anode, a fuse link, and a cathode stacked sequentially in a direction perpendicular to a substrate, a size of the anode being smaller than a size of the cathode.

9. The electrical fuse device of claim 8, wherein a width of at least part of the fuse link contacting the anode increases toward the anode.

10. The electrical fuse device of claim 8, wherein portions of the cathode around the fuse link extend toward the anode.

11. The electrical fuse device of claim 8, wherein the cathode includes,
a first region and a second region, the second region being arranged between the first region and the fuse link, a width of the second region being greater than a width of the first region.

12. The electrical fuse device of claim 11, wherein the width of the second region increases toward the fuse link from the first region.

13. The electrical fuse device of claim 11, wherein the width of the second region is constant.

14. The electrical fuse device of claim 8, wherein a portion of the cathode and a portion of the anode vertically overlap one another.
